(19) United States
(12) Patent Application Publication
(10) Pub. No.: US 2022/0048487 A1
(43) Pub. Date: Feb. 17, 2022

(54) DISTRIBUTED REGULATOR STRUCTURE FOR ACHIEVING OPTIMISED REGULATOR PROPERTIES AND INCREASED VALVE SERVICE LIFE

(71) Applicant: KNORR-BREMSE SYSTEME FÜR SCHIENENFAHRZEUGE GMBH, Munich (DE)

(72) Inventors: Marcus FISCHER, Munich (DE); Michael HOLZ, Munich (DE); Marc-Oliver HERDEN, Munich (DE); Jörg-Johannes WACH, Munich (DE)

(21) Appl. No.: 17/274,429

(22) PCT Filed: Aug. 6, 2019
(86) PCT No.: PCT/EP2019/071116

§ 371 Date: Mar. 8, 2021

(30) Foreign Application Priority Data
Sep. 7, 2018 (DE) 10 2018 215 295.0

(51) Int. Cl. B60T 13/68; B60T 8/50

(52) U.S. Cl. CPC B60T 13/68; B60T 8/5012

(57) ABSTRACT

A device regulates a pneumatic brake pressure of a vehicle and includes an inlet opening configured to be connected to a pressure accumulator, at least one outlet opening configured to be connected to a brake device to activate same, and at least two actuator elements arranged between the inlet opening and the at least one outlet opening and configured to influence a brake pressure between the inlet opening and the at least one outlet opening. In addition, a control device, a system, a brake system, a method and a computer program product are disclosed.

### CROSS REFERENCE AND PRIORITY CLAIM

This patent application is a U.S. National Phase of International Patent Application No. PCT/EP2019/071116 filed Aug. 6, 2019, which claims priority to German Patent Application No. 10 2018 215 295.0, the disclosure of which being incorporated herein by reference in their entireties.

### FIELD

Disclosed embodiments relate to a device, to a control device, to a system and to a brake system for influencing a brake pressure of a vehicle, in particular of a rail vehicle. Furthermore, disclosed embodiments relate to a method and to a computer program product for influencing the brake pressure of a vehicle.

### BACKGROUND

In order to influence the brake pressure, in particular the pneumatic brake pressure, of a vehicle (pilot control) valves are used. Generally, during the regulation of pressure there is a conflict in terms of objectives between the required switching cycle numbers and the achievable accuracy or the implemented magnitude and gradient of individual jumps in pressure. The latter act directly on the quality of the pressure regulation. In this context, a jolt can be felt in the vehicle as a result of the stepwise change in the pressure and, therefore, the deceleration. This jolt adversely affects the driving comfort. In addition, negative effects, in particular wear effects, are experienced on components which are used in the corresponding brake system. The achievable accuracy and the tolerances act directly on the achievable braking distance accuracy.

### SUMMARY

The disclosed emboidments resolve the conflict in respect of objectives as described above, between rapid influencing and precise influencing of the brake pressure while having the smallest possible influence on the service life of the valves which are used.

### BRIEF DESCRIPTION OF THE FIGURES

The description of disclosed embodiments will be given with reference to the appended drawings, in which, in particular:

FIG. 1: shows a basic illustration of a device according to the disclosed embodiments,

FIG. 2: shows a basic illustration of a system according to the disclosed embodiments,

FIG. 3: shows a flow diagram of the method according to the disclosed embodiments, and

FIG. 4: shows a further flow diagram of the method according to the disclosed embodiments.

### DETAILED DESCRIPTION

Conventionally, in order to keep the effects on the brake distance and the jolting as low as possible, the use of an increased number of switching cycles (e.g., per braking operation, per pressure ramp, etc.) is provided. However, this results in a reduction in the service life of the valves which are used.

Furthermore, different properties of the regulating operation (venting capacity, regulating accuracy, etc.) are necessary for different applications, e.g. for regulating the brake pressure of the service brake or emergency brake or for an anti-slip intervention. If both functions are integrated simultaneously into one valve, this results in conflicts in terms of objectives.

Conventionally, different actuator elements are used for different pressure regulating tasks, the actuator elements having specific advantages and disadvantages. In general, relay valve solutions and piston valves or diaphragm valves are used here, the latter valves being required specifically for use for anti-slip control, since rapidly switching valves are required in this context, in order to avoid damage to the wheelsets of the vehicle.

The disclosed emboidments resolve the conflict in respect of objectives as described above, between rapid influencing and precise influencing of the brake pressure while having the smallest possible influence on the service life of the valves which are used. The term “influencing the brake pressure” is to be understood here as meaning both open-loop and closed-loop control of the brake pressure.

In the text which follows, the term “influencing of a brake pressure” is always to be understood as meaning the open-loop and/or closed-loop control of a brake pressure.

According to the disclosed embodiments, a device for influencing a brake pressure of a vehicle, in particular of a rail vehicle, is provided with an inlet opening which is designed to be connected to a pressure accumulator, an outlet opening which is designed to be connected to a brake device for the activation thereof, and with at least two actuator elements which are arranged between the inlet opening and the outlet opening and are designed to influence a brake pressure between the inlet opening and the outlet opening.

Therefore, the brake pressure can optionally be regulated using one or other of the actuator elements.

The actuator elements are optionally designed to influence the brake pressure by means of an open-loop or closed-loop control method. The actuator elements are for this purpose optionally embodied as part of an open-loop controller or a closed-loop control circuit which is designed to influence the brake pressure in accordance with specified variables or setpoint variables.

The brake pressure is optionally a pneumatic pressure, and the actuator elements are embodied as pneumatic actuator elements. However, other embodiments are also conceivable which operate with another medium instead of compressed air. It is, therefore, possible also to use the disclosed embodiments to influence hydraulic brake pressures.

The at least two actuator elements are optionally connected to one another in parallel and/or in series.

Moreover, further circuit combinations are conceivable, for example parallel circuits and series circuits can optionally be combined. In addition, actuator elements can be provided not only for a bogie of a vehicle or for an entire car but optionally for each wheelset and particularly optionally in individual wheel suspension for each wheel, or else also for each brake actuator.

The at least two actuator elements are optionally to be assigned to the type of relay valves and/or piston valves and/or diaphragm valves and/or some other type.

Furthermore, at least two actuator elements are optionally connected in parallel if they are of the same type and/or identical. Identical actuator elements are to be understood here as actuator elements which are e.g. of identical design or which are similar in a property such as, for example, maximum flow capacity, switching speed, etc. which is decisive for the use of the valves. Therefore, the term identical valves is to be understood here as meaning e.g. also valves which permit the same performance if the performance is decisive.

It is, therefore, advantageously possible to ensure that the switching behavior of a certain type is distributed among a plurality of branches of the device so that these branches can be switched independently of one another.

The different types always have advantages and disadvantages in respect of their behavior, in particular in respect of the transmission behavior of the actuator elements. Relay valves, which are usually switched by means of a control pressure, on the basis of which they apply a corresponding working pressure, have the advantage that they can be used to implement gentle pressure profiles, on the basis of an internal damping effect, between two pressure levels. Furthermore, this is possible with a relatively low number of (switching) cycles. However, it is found to be disadvantageous that relay valves have a comparatively slow switching behavior, and also pressure ramps can be implemented only with limited gradients in comparison with other types of valve, for which reason other types are to be optionally preferable over them, for example in applications which require a high ventilation capacity and venting capacity. Therefore, this type is in particular not used for anti-slip control processors.

Furthermore, diaphragm valves are known which are distinguished by short reaction times and thus very high dynamics. These valves are additionally suitable for implementing high ventilating capacities and venting capacities as well as high performance densities. A disadvantage of this type of valve is the relatively hard pressure jumps which arise during switching, as a result of which disadvantages can arise in respect of comfort and service life. In addition, with these valves it is generally possible to implement only two states (open/closed), which can possibly bring about an increased switching cycle number when a pressure is being regulated.

In respect of advantages and disadvantages, it is also possible to assign piston valves to the diaphragm valves. The latter are also distinguished, for example, by high dynamics.

The device also optionally has a housing with the inlet opening and the outlet opening, particularly optionally with a plurality of inlet and outlet openings, wherein the actuator elements are arranged in the housing.

It is, therefore, possible for the device to be easily protected against environmental influences given a correspondingly designed housing, wherein the mounting of the device is advantageously facilitated since only one component has to be mounted instead of a plurality of components.

The device optionally has at least one controller which is designed to perform open-loop and/or closed-loop control of at least one of the at least two actuator elements, in order to influence the brake pressure.

The corresponding controller optionally has a microcontroller which processes a control method, defined by a program code, and which is particularly optionally designed to execute a different method by means of changes to this program code. It is, therefore, advantageously possible to easily change the regulating strategy of the corresponding controller.

In order to change the program code, interfaces are optionally provided, so that, for example a change can be made via an interface, for example a BUS interface by virtue of the fact that new program code can be transmitted to the controller via a data BUS which is present in the vehicle. Alternatively or additionally, the transmission optionally takes place via an interface which is provided on a housing of the controller.

The device additionally optionally has at least one sensor, in particular embodied as a sensor, which is designed to sense state variables of the at least two actuator elements and/or of the vehicle.

In this way, for example brake pressures which are present can be sensed in order to influence them subsequently by means of the actuator elements, or the speed of the vehicle and/or a wheel rotational speed, on the basis of which the brake pressure which is applied can be changed.

According to the disclosed embodiments, a control device, in particular for selecting actuator elements of a device as described above is further provided, having a controller which is designed to make a selection of the actuator elements to be controlled, between the inlet opening and the outlet opening, and having at least one input interface which is designed to receive values of at least one state variable of the device and/or of the vehicle, and having at least one output interface which is designed to transmit control variables to the device, in particular to the at least one controller.

The controller can optionally have a microcontroller here, or the controller is particularly optionally located in the form of program code on a microcontroller which is already present. If the controller is embodied as a separate element, it can optionally be integrated into the device described above, in particular into a possibly present housing of the device.

The controller, in particular the microcontroller, is optionally designed to control the device according to the disclosed embodiments.

It is, therefore, advantageously possible to select different actuator elements, such as described above, in a reasonable and situationally appropriate fashion.

The control device optionally has at least one input interface which is designed to receive values electronically and/or in digital form, in particular via a BUS connection and/or via sensors, in particular of the device described above.

Sensors, are in this context optionally such means or sensors which are already provided on the vehicle and whose values are accessed by the control device.

The control device can thus advantageously access information of the vehicle such as, for example, the speed of the vehicle, the wheel slip, the current braking force and the like and determine a vehicle state therefrom, on the basis of which the control device can subsequently optionally select a regulating strategy and make a corresponding selection of the actuating elements.

Furthermore, sensors, are optionally provided which are designed to determine at least one state variable of the device and/or of the vehicle. By means of the latter, the control device optionally receives values which are not already available from sensors which are already present.

According to the disclosed embodiemnts, in addition a system is provided for influencing a brake pressure of a vehicle which has at least one device as described above and at least one control device which is as described above. In this context, the at least one control device is designed to influence the device, in particular the actuator elements thereof, directly or indirectly via controllers which are designed for that purpose, in order to perform open-loop and/or closed-loop control of a brake pressure.

The control device is connected here to the device in such a way that it can perform, optionally electronically, open-loop and/or closed-loop control thereof.

An existing vehicle with an existing brake system can, therefore, advantageously be integrated into such a system, as result of which the existing brake system is able to overcome the conflict in terms of objectives as described and carry out correspondingly different braking regulation processes using different actuator elements.

The control device in this embodiment is optionally integrated into the device so that a compact structural unit can be formed.

In another embodiment of the system according to the disclosed embodiments, the device and control device are integrated in a common housing.

According to the disclosed embodiments, a brake system is also provided for influencing a pneumatic brake pressure of a vehicle which has a system as described above, at least one brake device which is designed to be actuated via the system, and at least one pressure accumulator which is designed to make available a pressure medium to the system.

The system, brake device and pressure accumulator are optionally connected here via lines, in particular via pneumatic or hydraulic lines.

It is, therefore, advantageous for a vehicle to be equipped with such a brake system or for the brake system to be installed as such into new vehicles.

According to the disclosed embodiments, a method for influencing, in particular for regulating, a brake pressure with a control device as described above is provided, which method carries out the operations of “selecting a granularity” and “selecting a strategy” and subsequently carries out the influencing of the brake pressure.

This is optionally done on the basis of the available information, which is particularly optionally transferred to the control device. If a selection is made for granularity and strategy, in a further operation the influencing of the brake pressure is carried out by the controller and/or the actuator elements.

The selection of the granularity can be characterized here, in particular, in respect of the method of actuation of individual brake devices, in particular by means of individual actuator elements. For example, granularities in respect of a wheel, a wheelset, a bogie, a car and/or an actuator are conceivable.

The strategy in turn describes how the influencing of the brake pressure has to take place. That is to say it is defined whether, for example, strong braking as far as an emergency braking, comfortable braking or anti-slip-regulated braking takes place.

In addition, when the strategy is selected a selection of the actuator elements to be used is optionally made, in order to implement the influencing of the brake pressure. The actuator elements are optionally selected in accordance with the type of braking operation and/or in accordance with the type of influencing of the brake pressure, according to their type and/or according to their properties. The type is, as described above, associated with advantages and disadvantages. Therefore, optionally in the case of emergency braking, actuator elements of a type are selected which respond relatively quickly, whereas in the case of a normal service braking operation optionally actuator elements of a type are selected which permit the brake pressure to be influenced in a relatively comfortable way, in particular for passengers.

A further operation of the method optionally consists in checking as to whether an anti-slip request is present. If this is the case, the processing of the method described here is ended, and a safety-relevant regulating operation, particularly optionally an anti-slip control process, is optionally changed over to. If the braking is ended, the method according to the disclosed embodiments is also ended. However, this operation is optional. An anti-slip control process can also be carried out by means of the method according to the disclosed embodimetns.

A further operation is optionally provided in which a pressure level within the device is set by means of at least one actuator element which is optionally connected to the inlet opening.

In this context, a pressure level is optionally provided which is present at at least one actuator element which is designed to set the pressure at at least one outlet opening of the device. This actuator element can set the pressure at the at least one outlet opening on the basis of this pressure level. Therefore, a maximum pressure which corresponds to this pressure level can be set at the outlet opening. A lower pressure can be set at the outlet opening on the basis of this maximum pressure.

Alternatively or additionally, a setpoint pressure is set at at least one outlet opening by means of at least one actuator element which is optionally connected to the outlet opening.

The setpoint pressure corresponds here to a desired pressure which is to be present at at least one outlet opening.

The pressure level within the device is optionally set by switching the at least one actuator element, which is optionally connected to the inlet opening, into an open position.

Alternatively or additionally, the setpoint pressure is set by the at least one actuator element, which is optionally connected to the outlet opening, being switched into an open position.

The respective actuator element is optionally provided directly connected to the inlet or outlet opening here, or intermediate elements, such as further actuator elements, are provided between the respective actuator element and the inlet opening or outlet opening.

The setting of the pressure level by means of actuator elements connected in the open position advantageously reduces the switching cycle numbers here.

Furthermore, a computer program product with a program code which is stored on a machine-readable carrier is provided according to the disclosed emboidments, wherein the program code is designed, when run on an electronic data processing system such as a control device, optionally a control device according to the disclosed embodiments, a controller, a microcontroller, an FPGA or a hardware-based implementation of the data processing system, in a vehicle, to cause the vehicle, a device according to the disclosed embodiments or a control device to carry out the method described above.

The presently disclosed embodiments are not limited to the features described above. Instead, further embodiments are conceivable which also come within the claimed scope of protection of this application and which can be obtained by interchanging individual features or combining them in new ways. For example, in the method described above it is possible to interchange individual operations or else to process them repeatedly. For example, a selection of the strategy can also be carried out according to the selection of the granularity. Furthermore, instead of compressed air it is also possible to use a different pressure medium, for example a different gas, or a liquid medium, in particular oil.

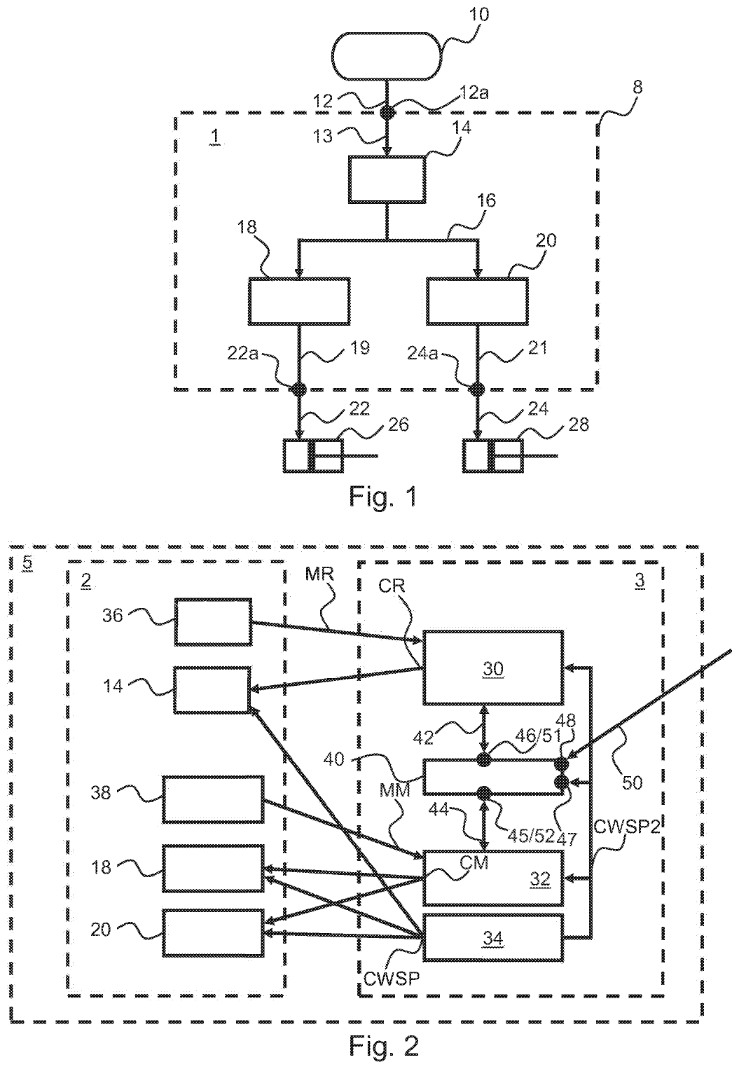

FIG. 1 shows a basic illustration of a device 1 according to the disclosed embodiments. A pressure accumulator 10, in particular a compressed air accumulator, which is connected via a supply line 12, which is connected to an inlet opening 12a of a housing 8 of the device 1. The device 1 is supplied with a pressure medium, referred to below as compressed air, by the pressure accumulator 10. However, other embodiments in which other media can be used are also conceivable.

The pressure accumulator 10 does not have to be connected directly to the device 1, as illustrated here. Instead, it can also be connected to other devices 1, wherein the device is then implemented, for example, by means of a branching supply line 12.

A relay valve 14, which receives compressed air via a connecting line 13 which adjoins the inlet opening 12a is arranged within the device 1. The relay valve 14 is designed to produce a connection between the inlet opening 12a and a downstream connecting line 16 on the basis of a control signal in the form of a control pressure. The relay valve 14 is designed to conduct a pressure from the supply line 12 into the connecting line 16. In addition, the relay valve 14 is designed to vent the connecting line 16, in order to reduce an existing pressure in the connecting line 16. A line for feeding the control pressure to the relay valve 14 as well as lines and openings for venting have not been illustrated in this drawing.

The connecting line 16 has a junction into two branches, wherein the two branches are connected to one diaphragm valve 18, 20 each.

In further embodiments (not shown) further junctions of the connecting line 16 can also be provided. In addition, further devices are also conceivable in which the supply line 12 also branches and supplies, for example, a plurality of relay valves 14.

The diaphragm valves 18, 20 are for their part connected via connecting lines 19, 21 with outlet openings 22a, 24a, provided on the housing 8 of the device 1, to brake lines 22, 24, wherein the diaphragm valves 18, 20 are designed to conduct a pressure from the connecting line 16 into the respective brake lines 22, 24. In addition, the diaphragm valves 18, 20 are designed to vent the brake lines 22, 24 in order to reduce a pressure which is present in the brake lines 22, 24.

As an alternative to the diaphragm valves 18, 20, piston valves can also be provided here, for example.

The brake lines 22, 24 are connected to the outlet openings 22a, 24a of the housing 8 of the device 1. Two brake cylinders 26, 28 are arranged mounted downstream of the latter, wherein the brake cylinders 26, 28 can be supplied with compressed air via the brake lines 22, 24 in order to be activated and can be vented again in order to release the brakes.

The brake cylinders 26, 28 are designed to activate the brakes (not illustrated) of the vehicle. This is done by conducting compressed air via the brake lines 22, 24 into the brake cylinders 26, 28. In order to release the brakes, the air is let out of the brake cylinders 26, 28 again.

The device 1 as presented in FIG. 1 merely represents a general case of the disclosed embodiments. A field of use of the device 1 according to the disclosed embodiments is the construction of rail vehicles. Rail vehicles generally have a plurality of wheelsets which are composed of a left-hand and right-hand wheel which are arranged on a common axle. A plurality of wheelsets are usually arranged in combination on bogies, wherein such a bogie is connected to a car body lying above. The device 1 which is shown in this illustration can, therefore, also be embodied in such a way that pressures can be made available to individual bogies via the brake lines 22, 24, wherein the lines are distributed there among a plurality of brake cylinders 26, 28. Furthermore, it is also possible to provide more than the two diaphragm valves 18, 20 which are shown here and which, for example, each actuate individual brake cylinders 26, 28. Moreover, further arrangements or connections of the actuator elements 14, 18, 20 are also conceivable.

In this way, various braking concepts can be influenced. In particular, concepts are conceivable here in which braking is carried out on a wheel basis, actuator basis, wheelset basis, bogie basis or car basis, wherein in the case of wheelset-based braking a brake brakes a common axle of a wheelset.

The illustrated device 1 has two stages which the compressed air has to flow through in order to pass from the pressure accumulator 10 as far as the brake cylinders 26, 28. The first stage is formed by the relay valve 14, and the second stage by the diaphragm valves 18, 20. Here, further embodiments (not shown) are conceivable. For example, both stages can be interchanged so that the compressed air firstly flows into a diaphragm valve or piston valve and subsequently into two relay valves arranged in parallel. Moreover, it is also possible to provide further stages between or after the stages shown, and other or further kinds and/or types of valves.

For example, distributors can also be connected to the brake lines 22, 24 in a bogie basis, the distributors distributing a brake pressure of the brake lines 22, 24 for their part among the wheelsets of the respective bogie. The provision of further brake lines is also conceivable in order to supply further brake devices.

FIG. 2 shows a basic illustration of a system 5 according to the disclosed embodiments. Here, subdivision into a pneumatic part 2 and an electronic part 3 is shown.

The system 5 has here, in particular, a device 1 according to FIG. 1, and a control device 40 according to the disclosed embodiments. The device 1 is not illustrated here as in FIG. 1. For reasons of clarity, only the relevant elements from FIG. 1 are adopted here.

The pneumatic part 2 includes the actuator elements of the device 1 which are shown in FIG. 1, in particular the relay valve 14 and the diaphragm valves 18, 20. For reasons of clarity, illustration of the pneumatic connections from FIG. 1 has been dispensed with. Furthermore, the pneumatic part 2 has sensors 36, 38 which are designed to determine information about the individual actuator elements 14, 18, 20 and make it available. The sensors 36, 38 are usually sensors which are designed to determine information in the form of state data of the corresponding actuator elements 14, 18, 20 such as, for example, degrees of opening or applied pressures. The different types of actuator elements 14, 18, 20 are usually assigned different sensors 36, 38. In the illustration shown, the relay valve 14 is assigned the sensor 36, and the diaphragm valves 18, 20 are assigned the sensor 38. In a further embodiment (not shown), each diaphragm valve 18, 20 or each actuator element is assigned a separate sensor.

At this point it is to be noted that the pneumatic part 2 can also be supplemented by or replaced by a hydraulic part, but this does not limit the subject matter of the disclosed embodiments.

The electronic part 3 contains controllers 30, 32, such as, for example, a computing unit, in particular a microcontroller, and/or solenoid valves and/or pilot control valves which are designed to actuate the corresponding actuator elements 14, 18, 20. In this illustration, the controllers 30, 32 are also assigned to the corresponding types of the actuator elements 14, 18, 20. The controller 30, therefore, controls the relay valve 14, and the controller 32 controls the diaphragm valves 18, 20. For this purpose, the control connections CR, CM are provided, for example, in the form of control lines of a pneumatic and/or electrical kind. In a further embodiment (not shown), each diaphragm valve 18, 20 or each actuator element is assigned a separate controller.

In addition, the controllers 30, 32 receive information about the individual actuator elements 14, 18, 20 from the corresponding sensors 36, 38. The controller 30, which controls the relay valve 14, is, therefore, supplied with information about the relay valve 14 via the data connection MR. In the same way, the controller 32, which controls the diaphragm valves 18, 20, is supplied via the data connection MM with information about the diaphragm valves 18, 20. This information, therefore, forms in each case a feedback loop, which makes it possible for the actuator elements 14, 18, 20 to be regulated by the controllers 30, 32.

Furthermore the control device 40, which is arranged between the controllers 30, 32 in the illustration, is provided in the electronic part 3.

The control device 40 has a plurality of interfaces 45, 46, 47, 48, 51, 52 via which the control device 40 can receive information of the vehicle, in particular in the form of electronic data, and/or also output information or control instructions. Furthermore, the control device 40 has a controller which permits the control device 40 to process received information and output corresponding control instructions.

In the embodiment shown, the control device 40 does not have a direct connection to the pneumatic part 2, but control connections 42, 44 are present via which the control device 40 is capable, on the one hand, of actuating the controllers 30, 32 and, on the other hand, can access the information thereof from the sensors 36, 38. For this purpose, the control connections 42, 44 are connected to the interfaces, in particular the input interfaces 45, 46 and the output interfaces 51, 52 of the control device 40.

In addition, the control device 40 has a control and data connection 50 with which it can receive further information or instructions from the vehicle. This data connection 50 is connected to the control device 40 via the input interface 48.

The control device 40 is designed to make, as an intelligent switching means, a selection or a regulating strategy of the individual actuator elements 14, 18, 20, that is to say granularity and strategy. This is done on the basis of the received information via the control and data connections 42, 44, 50. Since there is no direct connection to the actuator elements 14, 18, 20, a regulating operation can take place indirectly by means of a trigger instruction to the corresponding controllers 30, 32.

In a further embodiment (not shown), the control device 40 is designed to actuate the actuator elements 14, 18, 20 directly via separate control connections. This can be done alternatively or additionally to the actuation described above.

Furthermore, a controller 34 is provided in the electronic part 3, which controller 34 has control connections CWSP to all the actuator elements 14, 18, 20 and via a control connection CWSP2 to the further controllers 30, 32 and the control device 40. Direct actuation of the actuator elements 14, 18, 20 is, therefore, possible by the controller 34, and indirect actuation is possible by influencing the further controllers 30, 32 and the control device 40.

The controller 34 is, therefore, designed to perform open-loop and/or closed-loop control of all the actuator elements 14, 18, 20 and at the same time to influence the further controllers 30, 32 and the control device 40. The controller 34 is designed to carry out an anti-slip control operation for the vehicle, wherein it is able, for example, to deactivate the controllers 30, 32 and the control device 40 via the control connection CWSP2, or to influence the means and the device in such a way that an anti-slip control operation is not put at risk by its control interventions.

The controllers 30, 32, 34 and the controller of the control device 40 are embodied, for example, as separate elements for processing data, in particular as a microcontroller or else as individual control algorithms on a common control device.

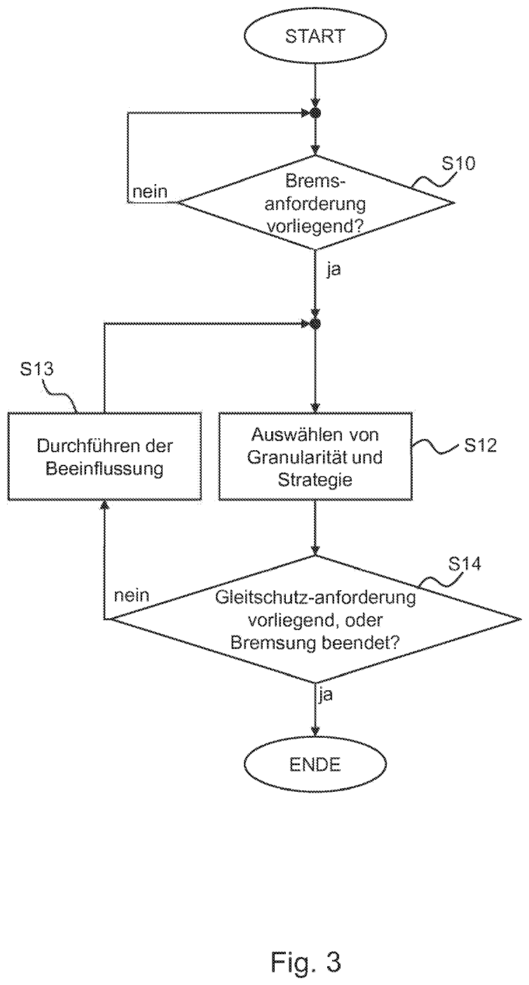

FIG. 3 illustrates a flow diagram of the method according to the disclosed embodiments. Firstly, it is checked in a operation S10 whether a braking request is present. This checking is carried out, for example, continuously during the journey. If a braking request is present, the method changes into operation S12 in which the selection of a corresponding strategy and granularity is carried out on the basis of underlying information of the operating state of the brake and/or of the vehicle.

Subsequent to this, in operation S14 it is checked whether there is an anti-slip request which would result in aborting of the method according to the disclosed embodiments, wherein an anti-slip control operation (not illustrated) would be subsequently changed over to. At the same time, in operation S14 it is checked whether there is still a braking request or whether the braking operation has ended. In this case, the method would also be ended, but without changing to an anti-slip control operation. Operation S14 is to be considered as optional here. That is to say there are embodiments which are also designed to carry out influencing of the brake pressure in terms of anti-slip protection.

If the requests in operation S14 are denied, the sequence of the method changes to operation S13, wherein the execution of the influencing of the brake pressure is carried out on the basis of the granularity and strategy defined in operation S12.

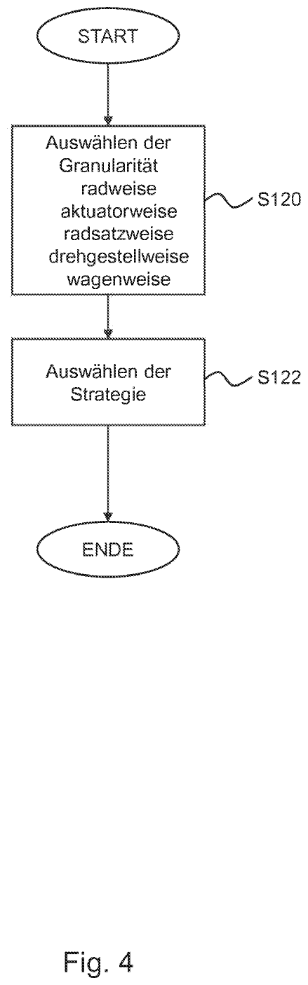

FIG. 4 illustrates the sequence of the operation S12 in more detail.

In operation S120, the selection of the granularity, for example on an actuator basis, wheel basis, wheelset basis, bogie basis and/or car basis takes place firstly.

Subsequently, the strategy with which the influencing of the brake pressure is to be carried out is selected in operation S122. In addition, the operation S122 includes the selection of the actuator elements which are to be used for the influencing of the brake pressure. This selection is carried out according to the type of the actuator elements, wherein depending on the situation other types of actuator elements are selected. If, for example, an emergency braking operation is to be carried out, actuator elements are selected which, according to their type, permit a rapid buildup of brake pressure. If normal service braking is to take place, actuator elements are selected which, according to their type, permit the brake pressure to be influenced in order to implement comfortable braking.

However, the operations S120 and S122 can basically also be implemented in the reverse order.

This sequence structure which is kept relatively general can implement a wide variety of combinations of granularities and strategies for influencing the brake pressure, which granularities and strategies will be explained in more detail below on the basis of disclosed examples.

### Wheelset-Based Regulating Operation

In the case of a wheelset-based regulating operation, the device 1 is embodied in such a way that it is capable of regulating the brake pressure of individual wheelsets, for example, of a bogie. Different brake pressures can be set during a braking operation, on the basis of the regulating strategy, e.g. at the wheelsets, since, for example, the wheels of the front wheelset can remove moisture from the rail and, therefore, transmit a lower braking force. In contrast, the wheels running behind are presented with a significantly drier rail, as result of which they can also be braked more intensively. A wheelset-based regulating operation is, therefore, appropriate.

One possible way of implementing a regulating operation with the device 1 according to the disclosed embodiments from FIG. 1 is to provide, by means of the relay valve 14, the maximum required brake pressure, that is to say the brake pressure for the wheelset which is to be braked most intensively. This wheelset is present at the diaphragm valves 18, 20 downstream of the relay valve 14 in the connecting line 16. In this example it is assumed that the wheelset which is to be braked more intensively is connected to the brake cylinder 26. Since the pressure in the connecting line 16 is the required pressure for the wheelset which is to be braked most intensively, its diaphragm valve 18 switches into an open position so that the pressure which is regulated by the relay valve 14 and which is located in the connecting line 16 is then conducted directly and without modification into the brake line 22 and the brake cylinder 26. The brake pressure of the brake cylinder 26 is, therefore, regulated by the relay valve 14. Since the brake cylinder 28 requires a lower brake pressure than the brake cylinder 26, its diaphragm valve 20 does not switch into an open position but rather regulates the required pressure in the brake line 24 and, therefore, in the brake cylinder 28. It is, therefore, possible to set a lower pressure in comparison with the connecting line 16, on the basis of a pressure in the connecting line 16 in the brake cylinder 28, by virtue of the fact that the diaphragm valve 20 does not permit compressed air to pass through, or only does so to a limited degree or discharges it to the atmosphere and, therefore, regulates the pressure.

This kind of regulating operation has the advantage that only one of the two diaphragm valves 18, 20 is used for the precise regulation of a brake pressure, as result of which the switching cycle number of the two diaphragm valves 18, 20 is reduced overall, which results in reduced wear of the components.

An alternative to the regulating operation described above is to specify a specific pressure level in the connecting line 16 by means of the relay valve 14, wherein a regulating operation of the individual wheelsets by means of the diaphragm valves 18, 20 subsequently takes place. The relay valve 14 here specifies a pressure level which in an extreme case corresponds to the maximum possible pressure from the pressure accumulator 10. The relay valve 14 is allocated a pilot control function here, raising a brake pressure in the connecting line 16 to a specific level. This occurs comparatively gently owing to the damping property of the relay valve 14. The actual regulating operation of the brake pressure occurs subsequently by means of the diaphragm valves 18, 20, which also require fewer switching cycles in this embodiment, since they only have to differ slightly from a preset pressure level of the relay valve 14.

### Actuator-Based Regulating Operation

In the same way, an actuator-based regulating operation can also be implemented so that the full brake pressure is applied, for example, to a brake actuator or a brake cylinder, wherein further actuators which are assigned to the same wheelset can have compressed air applied to them in a regulated fashion.

Regulating Operation with Small Differences Between the Wheelsets

If approximately the same braking forces are to be applied to the wheelsets, a further regulating approach can be selected. The relay valve 14 is used to set a pressure in the connecting line 16, which pressure corresponds, for example, to a maximum required pressure of all the wheelsets which are connected to the device 1. The downstream diaphragm valves 18, 20 merely compensate small pressure differences.

In this way, low-wear and comfortable braking is advantageously achieved, also requiring few switching cycles of the diaphragm valves 18, 20.

### Bogie-Based Regulating Operation

If, for example, a plurality of devices 1 are provided in the vehicle, there is in each case the possibility of setting a specific pressure level for each individual bogie via the relay valves 14 given a corresponding connection. The wheelset-based regulating operation is subsequently carried out with the individual diaphragm valves 18, 20 on the basis of this pressure level.

### Anti-Slip Regulating Operation

In addition, an anti-slip regulating operation can also be implemented with the device 1 as described.

In the case of braking with the maximum possible deceleration and/or in the case of wheel-rail contact with a low transmission capability of the forces between the wheel and rail, individual wheels or wheelsets run the risk of locking and slipping over the rail, which can entail a reduction in the braking force and damage to the wheel and rail. Therefore, such situations are to be avoided, and this can be achieved with an anti-slip regulating operation.

For this purpose, depending on the braking request the relay valve 14, for example, goes into the open position, which results in a defined pressure, for example the full pressure, from the pressure accumulator 10 being applied at the diaphragm valves 18, 20 via the supply line 12, the relay valve 14 and the connecting line 16. When in doubt the full brake pressure can be fed to the brake cylinders 26, 28. The diaphragm valves 18, 20 then apply the brake pressure which is required in the brake cylinders 26, 28. This regulating process has the advantage that the quickly responding diaphragm valves 18, 20 can quickly set the brake pressure in the brake lines 22, 24 between a maximum pressure, which corresponds to the pressure from the pressure accumulator 10, and a minimum pressure, which corresponds to atmospheric pressure, as well as corresponding intermediate stages. A quickly responding regulating process of the wheel slip of individual wheelsets is, therefore, possible.

Moreover, regulating methods which have been described up to now can take place not only on a wheelset basis or a bogie basis. Instead, further embodiments are conceivable such as, for example, a combinations of individual methods. The connection of the device 1 can also be implemented in a variety of ways, so that, for example, a separate bogie can be provided on each brake line 22, 24 or it is also possible for there also to be a plurality of diaphragm valves or piston valves, which also control the brake pressure on a bogie basis or wheelset basis or wheel basis or else actuator basis.

### LIST OF REFERENCE SYMBOLS

1 Device
2 Pneumatic part
3 Electronic part
5 System
8 Housing
10 Pressure accumulator (compressed air accumulator)
12 Supply line
12a Inlet opening
13 Connecting line
14 Relay valve (actuator element)
16 Connecting line
18 Diaphragm valve (actuator element)
19 Connecting line
20 Diaphragm valve (actuator element)
21 Connecting line
22 Brake line
22a Outlet opening
24 Brake line
24a Outlet opening
26 Brake cylinder (brake device)
28 Brake cylinder (brake device)
30 Controller (relay)
32 Controller (diaphragms)
34 Controller (anti-slip protection)
36 Sensor (relay)
38 Sensor (diaphragms)
40 Control device
42 Control connection
44 Control connection
45 Input interface
46 Input interface
47 Input interface
48 Input interface
50 Control and data connection (vehicle BUS)
51 Output interface
52 Output interface
CM Control connection
CR Control connection
CWSP Control connection
CWSP2 Control connection
MM Data connection
MR Data connection
S10 Is a braking request present?
S12 Selection of regulating strategy
S13 Carrying out regulating strategy
S120 Selection of regulating strategy
S122 Selection of actuator elements to be actuated
S14 Is anti-slip request present or is the braking operation ended?

1. A device for influencing a brake pressure of a vehicle, comprising:
an inlet opening configured to be connected to a pressure accumulator;
at least one outlet opening configured to be connected to a brake device in order to activate same, and
at least two actuator elements arranged between the inlet opening and the at least one outlet opening and configured to influence a brake pressure between the inlet opening and the at least one outlet opening.

2. The device of claim 1, wherein
the at least two actuator elements are connected in parallel and/or in series to one another and/or are configured to control the brake pressure by meant an open loop or closed loop control method, and/or
the brake pressure is implemented pneumatically or hydraulically.

3. The device of claim 1, wherein the at least two actuator elements originate from the type of relay valves and/or piston valves and/or diaphragm valves and/or some other type.

4. The device of claim 1, wherein the at least two actuator elements are connected in parallel when they are of the same type, in particular identical.

5. The device of claim 1, further comprising:
a housing with the inlet opening and the at least one outlet opening,
wherein the actuator elements are arranged in the housing.

6. The device of claim 1, further comprising:
at least one controller configured to perform open loop and/or closed loop control of at least one of the at least two actuator elements, to control the brake pressure, and/or
sensors configured to acquire state variables of the at least two actuator elements.

7. A control device for selecting actuator elements of the device of claim 1, the control device comprising having:
a selection controller configured to make a selection of the actuator elements to be controlled, the controller being positioned between the inlet opening and the at least one outlet opening, and
at least one input interface configured to receive values of at least one state variable of the device and/or of the vehicle, and
at least one output interface configured to transmit control variables to the device, to the at least one controller.

8. The control device of claim 7, wherein the at least one input interface is configured to receive values electronically and/or in digitally via a BUS connection, the sensors or via the at least one controller.

9. The control device of claim 7, further comprising:
state variable sensors configured to determine at least one state variable of the device and/or of the vehicle.

10. A system for influencing a brake pressure of a vehicle, having:
a device for influencing a brake pressure of a vehicle, the device having an inlet opening configured to be connected to a pressure accumulator, at least one outlet opening configured to be connected to a brake device in order to activate same, and at least two actuator elements arranged between the inlet opening and the at least one outlet opening and configured to influence a brake pressure between; and
at least one control device of claim 7,
wherein the control device is configured to influence the actuator elements of the device to perform open loop and/or closed loop control of a brake pressure.

11. A brake system for controlling a brake pressure of a vehicle, having:
a system of claim 10,
at least one brake device configured to be actuated via the system, and
at least one pressure accumulator configured to make available a pressure medium to the system.

12. A method for influencing a brake pressure with a device for influencing a brake pressure of a vehicle, the device having an inlet opening configured to be connected to a pressure accumulator, at least one outlet opening configured to be connected to a brake device in order to activate same, and at least two actuator elements arranged between the inlet opening and the at least one outlet opening and configured to influence a brake pressure between, wherein the method comprises:
selecting granularity,
selecting strategy, and
carrying out the influencing of the brake pressure.

13. The method as claimed in claim 12, wherein:
the method further comprises checking whether an anti slip request is present or the braking operation is ended, and/or
the selection of the granularity includes influencing the brake pressure on a wheel basis, wheelset basis, bogie basis, car basis and/or actuator basis, and the selection of the strategy includes a selection of the actuator elements to be used in terms of their type and/or properties.

14. The method of claim 12, further comprising:
setting a pressure level within the device by at least one actuator element coupled to the inlet opening; and
setting a setpoint pressure at at least one outlet opening by at least one actuator element coupled to the outlet opening.

15. The method of claim 14, wherein the setting of the pressure level within the device takes place such that the at least one actuator element coupled to the inlet opening is switched into an open position, and/or
wherein the setting of the setpoint pressure takes place such that the at least one actuator element coupled to the outlet opening is switched into an open position.

16. A non-transitory computer program product having a program code configured to run on a control device for selecting actuator elements of a device for influencing a brake pressure of a vehicle, wherein the control device has a selection controller configured to make a selection of the actuator elements to be controlled, the controller being positioned between the inlet opening and the at least one outlet opening, and at least one input interface configured to receive values of at least one state variable of the device and/or of the vehicle, and at least one output interface configured to transmit control variables to the device to the at least one controller, a controller, a microcontroller, an FPGA or a hardware based implementation of a data processing system, in a vehicle, to cause the vehicle to select granularity, select strategy, and carrying out the influencing of the brake pressure.
